(19) United States
(12) Patent Application Publication
(10) Pub. No.: US 2026/0203027 A1
(43) Pub. Date: Jul. 16, 2026

(54) CODE AND ARTIFACT GENERATION FOR SYNTHETIC DATA

(71) Applicant: Wells Fargo Bank, N.A., San Francisco, CA (US)

(72) Inventors: Marco Arriaga, Somerset, NJ (US); Jasmine de Gaia, Lewis Center, OH (US); Qian Cao, New Rochelle, NY (US)

(21) Appl. No.: 19/025,597

(22) Filed: Jan. 16, 2025

(51) Int. Cl. G06F 8/35; G06F 8/34

(52) U.S. Cl. CPC G06F 8/35; G06F 8/34

(57) ABSTRACT

This disclosure describes techniques for using a model to generate programming code for creating synthetic data and also to generate related code artifacts. In one example, this disclosure describes a method that includes generating, by an artificial intelligence model executing on a computing system and based on a source dataset, code capable of generating synthetic data patterned after the source dataset; outputting, by the computing system, a user interface presenting information about attributes of synthetic data that the code is capable of generating; accessing, by the computing system, adjustment data; and generating, by the artificial intelligence model and based on the adjustment data, updated code capable of generating synthetic data patterned after the source dataset.

### TECHNICAL FIELD

This disclosure relates to data processing, and more specifically, to techniques for generating synthetic data.

### BACKGROUND

Synthetic data is artificially generated information that mimics real-world data and is generated using a variety of techniques that aim to replicate the statistical properties of the real-world data. For example, synthetic data can be generated using relatively simple and transparent methods, such as rules-based data generation systems. Increasingly, however, synthetic data is generated using more complicated and less transparent techniques, such as through neural networks. Once generated, synthetic data is used for a variety of purposes, such as training machine learning models.

### SUMMARY

This disclosure describes techniques for using a model to generate programming code for creating synthetic data and also to generate related code artifacts. As described herein, the programming code, when executed by a computing system, is capable of generating synthetic data that is very similar to data presented to the model as input. In some examples, the model is a neural network capable of generating programming code in a specified language, written in a way that has a form similar to code written by a human developer. Accordingly, the programming code can be evaluated and analyzed by a computing system or a human subject matter expert or developer, and it is therefore possible to gain a full understanding of how the model-generated code generates synthetic data. In addition, the model may create related code artifacts that facilitate the analysis and understanding of the programming code and how it operates, particularly for analyses performed by a human subject matter expert or data scientist.

With an understanding of how the programming code operates, a computing system or human subject matter expert can identify and seek to correct flaws or other issues in the methodology embodied in the code generated by the model. Such flaws or other issues may take the form of various biases, inaccuracies, and problematic data distributions. As described herein, adjustment data can be generated that describes the flaws or other issues, and the adjustment data can then be presented to the model as input. The model may then use the adjustment data to generate an updated set of code that addresses the described flaws or other issues. This process of analysis and adjustment can be repeated until the code generated by the model is deemed satisfactory. The code can then be used to generate synthetic data, which may be used for various purposes, including training machine learning models.

In some examples, this disclosure describes operations performed by a computing system in accordance with one or more aspects of this disclosure. In one specific example, this disclosure describes a method comprising generating, by an artificial intelligence model executing on a computing system and based on a source dataset, code capable of generating synthetic data patterned after the source dataset; outputting, by the computing system, a user interface presenting information about attributes of synthetic data that the code is capable of generating; accessing, by the computing system, adjustment data; and generating, by the artificial intelligence model and based on the adjustment data, updated code capable of generating synthetic data patterned after the source dataset.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

The details of one or more examples of the disclosure are set forth in the accompanying drawings and the description herein. Other features, objects, and advantages of the disclosure will be apparent from the description and drawings, and from the claims.

### BRIEF DESCRIPTION OF THE DRAWINGS

FIG. 1 is a conceptual diagram of a system that creates programming code for generating synthetic data, enables analysis and modification of the code, and generates synthetic data using the modified code, in accordance with one or more aspects of the present disclosure.

FIG. 2 is a block diagram of a system that creates programming code for generating synthetic data, enables analysis and modification of the code, and generates synthetic data using the modified code, in accordance with one or more aspects of the present disclosure.

FIG. 3A through FIG. 3D are conceptual diagrams illustrating example user interfaces presented by a user interface device in accordance with one or more aspects of the present disclosure.

FIG. 4 is a flow diagram illustrating operations performed by an example computing system in accordance with one or more aspects of the present disclosure.

Although each of the above-described Figures are referenced herein in connection with the description of one or more specific examples, such examples are merely illustrative, and each illustration can be used to provide support for other examples not specifically described herein. Accordingly, the one or more examples described herein with reference to any of the above-described Figures should not be construed to narrow the scope or spirit of the subject matter illustrated or otherwise disclosed herein.

### DETAILED DESCRIPTION

Synthetic data can play an important role in artificial intelligence (AI) by providing a versatile and scalable solution for training and testing AI models. Unlike real-world data, synthetic data can be generated in vast quantities and can be tailored to specific needs, ensuring a diverse and comprehensive dataset. This is particularly beneficial in scenarios where real data is scarce, expensive, or sensitive, such as in medical research or financial services. By using synthetic data, model developers can simulate a wide range of conditions and edge cases, improving the robustness and accuracy of their models, and enabling more extensive experimentation and validation of algorithms.

Modern techniques for generating synthetic data provide the ability to create large, diverse datasets without the privacy concerns associated with real data. This is useful in many fields, such as healthcare, because synthetic data can be used to protect patient confidentiality. If generated properly, synthetic data does not contain any real personal or private information and does not contain any actual data points from the original source datasets (which typically contain real-world data).

Synthetic data can also help overcome the limitations of small or imbalanced datasets, providing a more robust training ground for machine learning models. Additionally, synthetic data techniques allow for the testing of algorithms under a wide range of scenarios, enhancing their generalizability and performance. By using synthetic data, researchers and developers can innovate more freely and safely, accelerating the development of advanced models.

However, a common concern for data scientists and/or subject matter experts using synthetic data stems from what is often a lack of transparency, meaning data scientists might not have a clear understanding of how and why a given item of synthetic data has been generated. This lack of understanding often results in a lack of confidence in the synthetic data, since the data scientist does not know exactly where the data is coming from or what logic was used to generate it.

Accordingly, in at least some cases, a rule-based system for generating synthetic data tends to have some advantages, since rules-based systems are often easier to understand. However, rules or programming code applied in a rules-based approach to generating synthetic data are typically created manually by developers, and creating the rules can consume significant developer time. For example, to create a rule that generates synthetic social security numbers, a developer needs to specify, through rules or code, the specific format of the social security number (e.g., a nine-digit number that starts with three digits, then adds a dash, then two more digits, followed by another dash and four more digits).

Rather than requiring a developer to manually create the rules for a social security number, it would be more efficient to present a list of valid social security numbers to an AI model and enable the AI model to learn the attributes of a social security number and generate a rule (or software code) that can be used to create synthetic social security numbers. Notably, the AI model in this situation is not necessarily being trained on the list of valid social security numbers to create new synthetic data. Instead, the AI model is being trained on that data to create a rule or code that can be used to generate data having the same form as the list of social security numbers. In more complex cases, an AI model might be used to define a rule that could be tweaked or modified by an operator or developer to fit a specific set of parameters (e.g., the AI model could create a general rule that can be adjusted using an input parameter so that it generates data having a specified gender distribution or a specific geographical distribution).

This disclosure describes techniques for using an artificial intelligence model to generate programming code for creating synthetic data and to generate additional artifacts that facilitate the interpretation of that code and how it operates. As described herein, the code or the artifacts can be evaluated and modified as appropriate to adjust the methodology used to generate synthetic data. The adjustments may take the form of adjustment data that can be used and/or translated by the model when generating an updated set of programming code and related artifacts. Further adjustments may be made to the updated set of programming code and/or related artifacts, and these further adjustments may be used by the model when generating further updated sets of programming code and related artifacts. This process may continue in an iterative fashion until a satisfactory or optimal set of rules or programming code is generated by the model. This process may enable a data scientist or subject matter expert to better understand, visualize, and/or control how the resulting code generates synthetic data.

The disclosed techniques may also be used to demonstrate to interested parties (e.g., corporate management, auditors, or government regulators) how a given set of synthetic data was generated, since the rules or code (and related artifacts) are available for analysis and evaluation in a fully transparent way. In general, using a complex model to generate human-readable programming code designed to generate synthetic data enables a synthetic data verification and/or explainability capability that creates transparency around the synthetic data generation process.

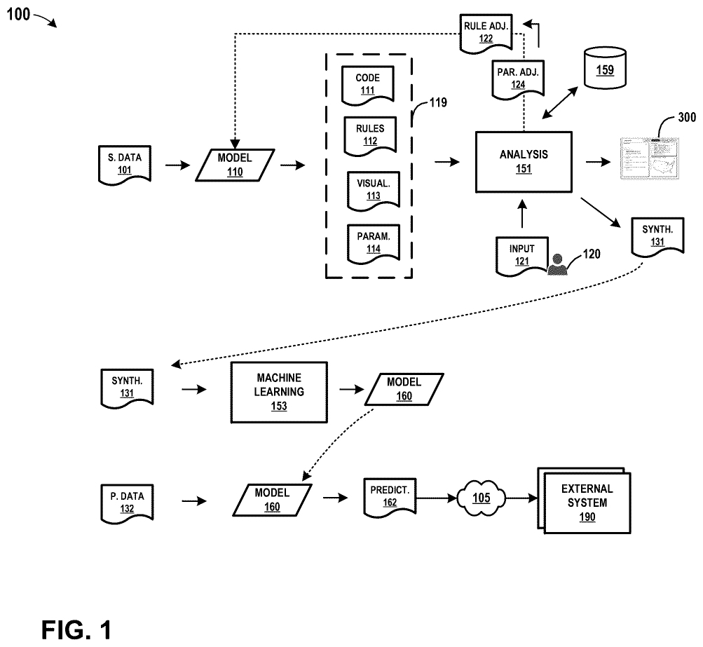

FIG. 1 is a conceptual diagram of a system that creates programming code for generating synthetic data, enables analysis and modification of the code, and generates synthetic data using the modified code, in accordance with one or more aspects of the present disclosure. FIG. 1 illustrates model 110, analysis system 151, and library 159, machine learning system 153, production model 160, and one or more external systems 190.

Model 110 is a model trained to analyze input data (e.g. source data 101) and generate various code artifacts 119, which may include human-readable programming code that, when executed on a computing system, can generate synthetic data having properties very similar to the input data. In at least some examples, model 110 does not necessarily generate synthetic data, but instead, model 110 generates programming code that is used to generate synthetic data (e.g., synthetic data 131). Model 110 may be implemented as a large language model or other neural network, and/or may be a model based on generative adversarial networks (GANs), variational autoencoders (VAEs), or other artificial intelligence processes.

Analysis system 151 is a computing system or collection of computing systems configured to receive code artifacts 119 and perform an analysis. Such an analysis may result in adjustments and/or modifications being made to the operation of model 110, where those adjustments and/or modifications are implemented by model 110 based on rule adjustment data 122 and parameter adjustment data 124. Such an analysis may also result in generating visualizations or user interfaces 300, storing or logging information in library 159, and/or other operations. In some examples, but not all, analysis system 151 may operate based on input from subject matter expert 120, developer, administrator, and/or other operator.

Machine learning system 153 uses synthetic data to train one or more models to make predictions for various purposes. Specifically, in FIG. 1, machine learning system 153 uses synthetic data 131 generated by code 111 to train production model 160. Production model 160 generates predictions or inferences (e.g., predictions 162) based on input data (e.g., production data 132). In some examples, predictions 162 are used to control one or more external systems 190 over network 105.

The operation of FIG. 1 can be illustrated through an example described in the context of FIG. 1, where a series of processes starting with source data 101 ultimately results in production model 160 being trained to make predictions that are used to control the operation of one or more external systems 190. In such an example, the series of processes starts with source data 101 being presented as input to model 110. In response, model 110 generates code artifacts 119, which include code 111, rules 112, visualization data 113, and parameter data 114.

Code 111 may be a computer program that can be used to generate data (i.e., synthetic data) having characteristics very similar to source data 101. Code 111 may be human-readable code written in any appropriate programming language (e.g., Python, Java, C#, others), and may have a form similar to (or even indistinguishable from) code written by a human developer. When executed on a computing system, code 111 generates synthetic data having properties very similar to the input data (i.e., source data 101). Accordingly, while model 110 might not necessarily generate synthetic data directly, code 111 generated by model 110 can be used to generate synthetic data.

Rules 112 may represent a description or summary of how code 111 operates. While code 111 might be human-readable, rules 112 might still be somewhat more accessible and easier for a human analyst or expert (e.g., subject matter expert 120) to understand quickly, at least compared to code 111 in some situations. Rules 112 (and related data) may include a list of fields detected within source data 101, and may describe the type of data and the characteristics of the data for each such field and how those characteristics can be reproduced in synthetic data. In one example, rules 112 may indicate that source data 101 includes an age field, and that the age range as determined by model 110 based on source data 101 spans from 21 to 90 years of age. Rules 112 may further indicate that code 111 generates synthetic data according to either a specified distribution or uniformly (e.g., where “uniformly” may mean randomly with an equal distribution of the ages from 21 to 90).

Visualization data 113 may include information that can be used to create an illustration of attributes of various fields of synthetic data that might be created by code 111. For example, visualization data 113 may include data that can form the basis for histograms, scatter plots, frequency distributions, contour diagrams, heat maps, and/or other types of illustrations that describe the synthetic data. In one example, visualization data 113 might include an illustration of the age range distribution for the age field specified in rules 112 and implemented by code 111.

Parameter data 114 may include information about assumptions made by model 110, which may be embodied in code 111. In some examples, model 110 may be configured to operate in a parameterized way, where the operation of model 110 changes based on parameters, and where those parameters might adjust assumptions made by model 110. For example, parameter data 114 might indicate that the source data 101 includes a list of people with a 48%/52% gender distribution, and may further identify a parameter within code 111 that can be used to modify that distribution. Specifically, parameter data 114 might indicate that code 111 will generate synthetic data that follows that 48%/52% distribution, but that distribution can be adjusted (e.g., changed to a 50%/50% distribution) by modifying the parameter.

Continuing with the example, after model 110 generates code artifacts 119, analysis system 151 may perform an analysis. For instance, in FIG. 1, code artifacts 119 output by model 110 are presented as input to analysis system 151. In response, analysis system 151 performs an analysis and verifies that code 111 would generate synthetic data that is consistent with source data 101. In some examples, analysis system 151 may identify instances where code 111 generates data consistent with source data 101, but code 111 nevertheless seems to generate inaccurate or inappropriate synthetic data. For example, analysis system 151 might determine that code 111 generates synthetic data that includes addresses in the United States, but the addresses are skewed toward addresses in U.S. states in one particular part of the country. In another example, analysis system 151 might determine that code 111 generates synthetic data with unusual or flawed age or gender distributions.

Analysis system 151 may perform such an analysis by accessing information stored in library 159, which may provide information about policies, standards, standard procedures, and/or conventions for generating various types of synthetic data. Such policies, standards, procedures, and/or conventions may, in some cases, be based on prior instances in which synthetic data was generated by an organization operating or using system 100 (and may therefore represent policies and/or standards used by that organization). In some examples, library 159 may include demographic, geographic, or other data that enables analysis system 151 to determine that code 111 might generate code inconsistent with actual distributions of such demographic, geographic, or other data.

In some examples, analysis system 151 may perform the analysis described above without input from a human user. However, in some examples, analysis system 151 may perform the analysis based on input 121, which may represent input or guidance from subject matter expert 120. In some cases, subject matter expert 120 may evaluate code 111, rules 112, visualization data 113, and/or parameter data 114 in order to perform the analysis. To enable a subject matter expert to assist with the analysis, analysis system 151 may generate one or more user interfaces 300, presenting information about code 111, rules 112, visualization data 113, and/or parameter data 114.

Analysis system 151 may modify or adjust how the code 111 operates. For instance, referring again to FIG. 1, analysis system 151 analyzes code artifacts 119. Analysis system 151 generates, based on the analysis of code artifacts 119, rule adjustment data 122. Rule adjustment data 122 may represent one or more modifications to rules 112 embodied in code 111 generated by model 110. Model 110 may use rule adjustment data 122 to modify how code 111 is written so that an updated version of code 111 generates synthetic data in a manner that is consistent with rule adjustment data 122. For example, rule adjustment data 122 might specify that even if source data 101 suggests that the gender distribution of the synthetic data should be 48%/52%, code 111 should be modified so that when executed, code 111 should generate synthetic data having only women for a specific use case. Or in another example, rule adjustment data 122 might specify that only California-based addresses should be generated.

In some examples, rule adjustment data 122 may be generated by analysis system 151 based on library 159, without necessarily using input from an administrator or subject matter expert 120. In other cases, analysis system 151 may generate rule adjustment data 122 based on input 121, which may include input or guidance from one or more subject matter experts 120. In some cases, input 121 may take the form of modifications to code 111. In other examples, input 121 may take the form of modifications to rules 112 or modifications to or markups of visualization data 113. In this latter case, analysis system 151 may interpret such modifications and determine how those modifications translate into changes to code 111, and those translated changes may be included within rule adjustment data 122.

Analysis system 151 may adjust parameters associated with code 111. For instance, still with reference to FIG. 1, analysis system 151 generates, based on the analysis of code artifacts 119, parameter adjustment data 124. Parameter adjustment data 124 may include information about how to make parameter-specified changes to the operation of model 110, resulting in code 111 that is capable of generating synthetic data that is consistent with those parameter-specified changes. For example, model 110 might generate, based on parameter adjustment data 124, code 111 that creates synthetic data having a parameter-specified geographic, age, gender, or other distribution or having other parameter-specified attributes (e.g., as described above, for example, applying the parameter that adjusts model 110 to ensure a 50%/50% gender distribution).

In some examples, parameter adjustment data 124 may include information that requires model 110 to generate code 111 that uses additional parameters that can be used to modify or adjust the synthetic data that would be generated by code 111. For example, while model 110 might automatically identify some data fields or data attributes as appropriate for parameterization, model 110 might not identify all desired options for parameters. Accordingly, parameter adjustment data 124 may enable analysis system 151 to specify additional parameter options and associated configurations. In some cases, such additional parameters might be identified by a subject matter expert 120 (and identified in input 121).

Model 110 may generate updated code artifacts 119. For instance, again referring to FIG. 1, and after analysis system 151 analyzes an initial version of code artifacts 119 and generates rule adjustment data 122 and parameter adjustment data 124, model 110 generates a new version of code artifacts 119. This time, however, model 110 generates code artifacts 119 based on input source data 101 and additionally based on rule adjustment data 122 and parameter adjustment data 124. The resulting code artifacts 119 reflect the changes indicated in rule adjustment data 122 and parameter adjustment data 124. Like the original code artifacts 119, the updated code artifacts 119 would, in most cases, include updated code 111, updated rules 112, updated visualization data 113, and updated parameter data 114.

Analysis system 151 may ultimately generate synthetic data 131. For instance, referring again to FIG. 1, analysis system 151 receives the updated code artifacts 119, and analyzes the updated code 111, updated rules 112, updated visualization data 113, and updated parameter data 114. Based on this analysis (which may include additional input 121 from subject matter expert 120), analysis system 151 generates new rule adjustment data 122 and/or parameter adjustment data 124. Model 110 then generates a further updated set of code artifacts 119 based on source data 101 and the new rule adjustment data 122 and parameter adjustment data 124. This process may continue, with model 110 repeatedly generating updated code artifacts 119 based on successive sets of rule adjustment data 122 and parameter adjustment data 124. Eventually, analysis system 151 determines (e.g., based on input 121 from subject matter expert 120 or otherwise) that the most recent version of code artifacts 119 (and specifically, code 111) are acceptable. Analysis system 151 then uses code 111 to generate synthetic data 131.

Analysis system 151 may also log information about the process of generating synthetic data 131. Such logged information may include information about the analyses performed by analysis system 151, changes to model 110 based on rule adjustment data 122 and parameter adjustment data 124, the synthetic data 131, and other attributes of the process performed by system 100.

System 100 may train a model using synthetic data. For instance, still referring to FIG. 1, machine learning system 153 receives synthetic data 131 as input. Machine learning system 153 uses synthetic data 131 as training data to train production model 160 to make predictions about input data that is similar to source data 101.

Once trained, production model 160 may generate predictions. For instance, in FIG. 1, production model 160 may be deployed in an environment in which it is presented with a series of production data 132. In response to being presented with production data 132, production model 160 generates predictions 162. In some examples, production model 160 may be part of a larger system involving other systems (e.g., one or more external systems 190). For instance, depending on the nature of production model 160, predictions 162 made by production model 160 may serve as control signals that control the operation of one or more external systems 190. Specifically, production model 160 may send control signals (in the form of predictions 162) to one or more external systems 190, instructing one or more of external systems 190 to perform a specific operation (e.g., adjust credit scores, enable or disable a healthcare process, modify network operations, generate an alert, enable or disable access to resources, change privileges). Accordingly, production model 160 (or system 100 generally) may control the operation of such external systems through predictions 162 made by production model 160.

As described, production model 160 is capable of making inferences or predictions when presented with input data, such as production data 132. If trained effectively, production model 160 will exhibit skill at making predictions based on data that is similar to synthetic data 131. For example, production model 160 may be a supervised learning model trained to predict creditworthiness based on attributes of credit card customers. If production data 132 is sufficiently similar to synthetic data 131, predictions made by production model 160 about the creditworthiness of credit card customers described in production data 132 will be relatively accurate. Therefore, it is important that synthetic data 131 be very similar to actual data (e.g., source data 101) that production model 160 will use to make predictions (e.g., production data 132). Ultimately, if synthetic data 131 is of high quality, production model 160 will be trained more effectively, and production model 160 will therefore be more skilled at making predictions 162 based on production data 132.

Techniques described herein may provide certain technical advantages. For instance, the process described in the context of FIG. 1 provides a level of transparency into how synthetic data is generated. This transparency may enable systems (e.g., analysis system 151) or human experts (e.g., subject matter expert 120) to analyze the rules and code that are used to generate synthetic data, and more effectively determine whether the synthetic data will be generated with any inappropriate biases or use of private information. This level of transparency may provide a level of confidence and/or assurance to data scientists that the synthetic data has been accurately and properly generated, which may lead to more effective use of synthetic data.

In addition, by providing transparency into how synthetic is generated, and enabling changes to that process to be made as appropriate, other processes can be performed quickly and efficiently, such as debugging, calibration, and evaluation of the quality of synthetic data. This may lead to faster deployment of models trained with synthetic data. This may also lead to the development of models that generate more accurate predictions, without revealing private information and without any inappropriate bias. Further, if the code used to generate synthetic (and other code artifacts 119) is stored, logged, or otherwise recorded, a library of data about how to generate synthetic data in various use cases, how to address potential biases, and/or how to create specific types of synthetic data can be maintained and used to enhance consistency and improve compliance with policy.

Still further, if code artifacts 119 associated with generation of synthetic data are maintained in a library, it may be possible to effectively and quickly respond to inquiries about deployed models or the process for training those models. Such inquiries may originate from regulatory agents, corporate management, privacy watchdogs, and other interested parties.

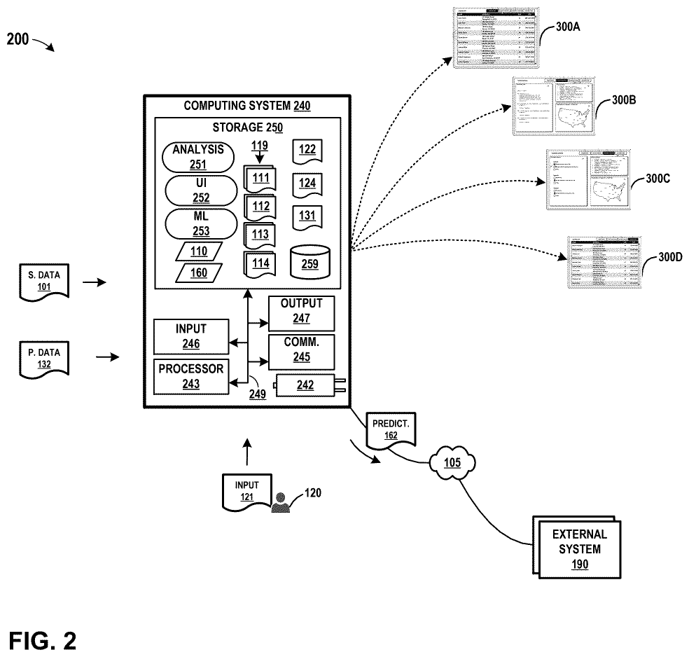

FIG. 2 is a block diagram of a system that creates programming code for generating synthetic data, enables analysis and modification of the code, and generates synthetic data using the modified code, in accordance with one or more aspects of the present disclosure. System 200 of FIG. 2 includes some of the same elements of system 100 described in connection with FIG. 1. Elements illustrated in FIG. 2 may correspond to earlier-described elements sharing the same reference numeral (e.g., source data 101, production data 132, prediction 162, external systems 190). Also illustrated in FIG. 2 is a block diagram of computing system 240, which may be considered an example or alternative implementation of a combination of elements included within system 100 of FIG. 1.

Computing system 240 is illustrated in FIG. 2 to facilitate a description of certain components, modules, and other aspects of a computing system that may implement a system for creating code and other artifacts for generating synthetic data, making inferences in production, and controlling one or more external systems. Computing system 240 is also illustrated in FIG. 2 to facilitate a description of how such a computing system may operate in accordance with techniques described herein.

In general, computing system 240 of FIG. 2 may operate in a manner similar to system 100 illustrated in FIG. 1. For example, computing system 240 may accept source data 101, and apply model 110 to generate code artifacts 119, which as described in connection with FIG. 1, may include code 111, rules 112, visualization data 113, and parameter data 114. Like analysis system 151 of FIG. 1, analysis module 251 may analyze the generated code artifacts 119 and based on the analysis, generate rule adjustment data 122 and/or parameter adjustment data 124. In some cases, but not all, analysis module 251 may generate rule adjustment data 122 and/or parameter adjustment data 124 based on input 121 from one or more subject matter experts 120. In other cases, analysis module 251 may generate rule adjustment data 122 and/or parameter adjustment data 124 autonomously.

Analysis module 251 of computing system 240 may use rule adjustment data 122 and/or parameter adjustment data 124 to make adjustments to how model 110 operates. Based on the adjustments, model 110 may generate a new set of code artifacts 119, which may include updated or rewritten code 111 that incorporates the changes specified in rule adjustment data 122 and/or parameter adjustment data 124. After sufficient adjustments are made, analysis module 251 may execute the final version of code 111 to thereby generate synthetic data 131.

Machine learning module 253 uses synthetic data 131 to train production model 160. Once trained, production model 160 accepts production data 132 as input. In response, production model 160 generates predictions 162. Production model 160 of computing system 240 may use predictions 162 to control one or more external systems 190 over network 105.

For ease of illustration, computing system 240 is depicted in FIG. 2 as a single computing system. However, in other examples, computing system 240 may be implemented through multiple devices or computing systems distributed across a data center, multiple data centers, multiple cloud networks, or otherwise. For example, separate computing systems may implement functionality described herein as being performed by each of various modules of computing system 240, including analysis module 251, user interface module 252, and machine learning module 253. Alternatively, or in addition, modules illustrated in FIG. 2 as included within computing system 240 may be implemented through distributed virtualized compute instances (e.g., virtual machines, containers) of a data center, cloud computing system, server farm, and/or server cluster.

In FIG. 2, computing system 240 is shown with underlying physical hardware that includes power source 242, one or more processors 243, one or more communication units 245, one or more input devices 246, one or more output devices 247, and one or more storage devices 250. One or more of the devices, modules, storage areas, or other components of computing system 240 may be interconnected to enable inter-component communications (physically, communicatively, and/or operatively). In some examples, such connectivity may be provided by through communication channels, which may include a system bus (e.g., communication channel 249), a network connection, an inter-process communication data structure, or any other method for communicating data. Although computing system 240 of FIG. 2 may be considered an example implementation of at least some aspects of system 100 of FIG. 1, other implementations are possible.

In the example shown in FIG. 2, power source 242 of computing system 240 may provide power to one or more components of computing system 240. Power source 242 may receive power from an alternating current (AC) power supply in a building, data center, or other location. In some examples, power source 242 may be or include a battery or a device that supplies direct current (DC). Power source 242 may have intelligent power management or consumption capabilities, and such features may be controlled, accessed, or adjusted by processors 243 to intelligently consume, allocate, supply, or otherwise manage power.

One or more processors 243 of computing system 240 may implement functionality and/or execute instructions associated with computing system 240 or associated with one or more modules illustrated herein and/or described herein. One or more processors 243 may be, may be part of, and/or may include processing circuitry that performs operations in accordance with one or more aspects of the present disclosure. Such processors may be mobile processors, desktop processors, server processors, compute nodes, virtualized processors, neural processing units or NPUs, graphics processing units or GPUs, and/or other types of processors or processing circuitry. Processors 243 may execute the instructions of one or more processes executing on computing system 240 and may implement functionality of such processes.

One or more communication units 245 of computing system 240 may communicate with devices external to computing system 240 by transmitting and/or receiving data, and may operate, in some respects, as both an input device and an output device. Communication units 245 may enable computing system 240 to communicate with other computing devices and systems using any appropriate communication protocol (e.g., TCP/IP) and over any appropriate medium. In some or all cases, one or more communication units 245 may communicate with other devices or computing systems over a network. For example, communication units 245 may enable computing system 240 to communicate with and/or control other systems or devices (e.g., external systems 190) over a network (e.g., network 105).

One or more input devices 246 may represent any input devices of computing system 240, and one or more output devices 247 may represent any output devices of computing system 240. Input devices 246 and/or output devices 247 may generate, receive, and/or process output from any type of device capable of outputting information to a human or machine. For example, one or more input devices 246 may generate, receive, and/or process input in the form of electrical, physical, audio, image, and/or visual input (e.g., peripheral device, keyboard, microphone, camera). Correspondingly, one or more output devices 247 may generate, receive, and/or process output in the form of electrical and/or physical output (e.g., peripheral device, actuator).

One or more storage devices 250 within computing system 240 may store information for processing during operation of computing system 240. Storage devices 250 may store program instructions and/or data associated with one or more of the modules described in accordance with one or more aspects of this disclosure. One or more processors 243 and one or more storage devices 250 may provide an operating environment or platform for such modules, which may be implemented as software, but may in some examples include any combination of hardware, firmware, and software. One or more processors 243 may execute instructions and one or more storage devices 250 may store instructions and/or data of one or more modules. The combination of processors 243 and storage devices 250 may retrieve, store, and/or execute the instructions and/or data of one or more applications, modules, or software. Processors 243 and/or storage devices 250 may also be operably coupled to one or more other software and/or hardware components, including, but not limited to, one or more of the components of computing system 240 and/or one or more devices or systems illustrated or described as being connected to computing system 240.

Analysis module 251 may perform functions relating to analysis and/or modification of code artifacts 119 generated by model 110. Analysis module 251 may perform an analysis to verify that code 111 would generate synthetic data 131 that is consistent with source data 101. Analysis module 251 may identify instances where code 111 generates data consistent with source data 101 but where code 111 nevertheless generates inaccurate or inappropriate data. To perform various analyses, analysis module 251 may access and/or rely on data stored in data store 259 or input from one or more subject matter experts 120. Analysis module 251 may also adjust code 111 based on its analyses, generate rule adjustment data 122 and/or parameter adjustment data 124, and cause model 110 to generate new or updated code 111 that addresses any biases, inaccuracies, or other issues with synthetic data generated by previous versions of code 111 generated by model 110. Analysis module 251 may also execute code 111 to generate synthetic data 131, which may be used to train other models (e.g., production model 160) or perform other analyses.

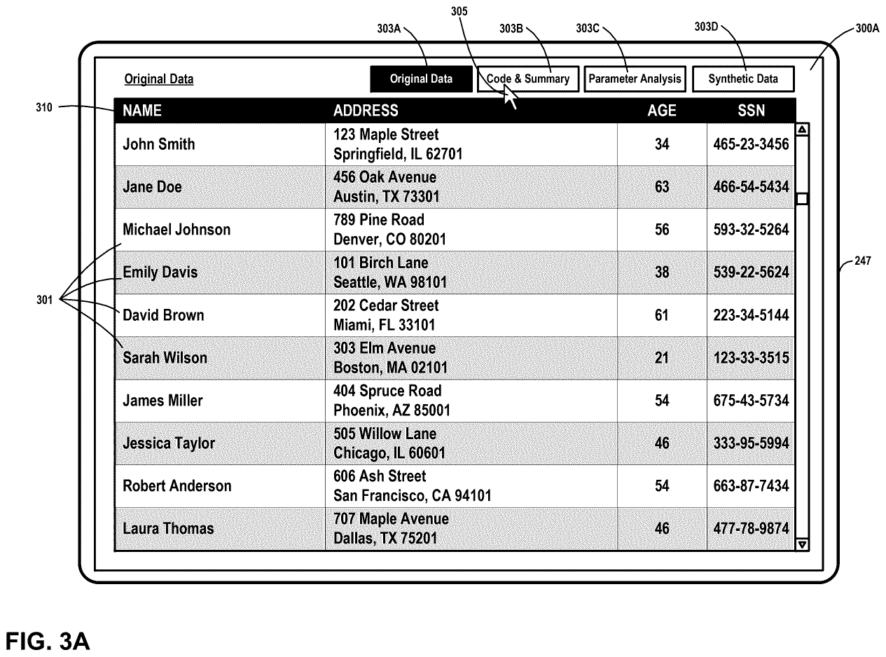

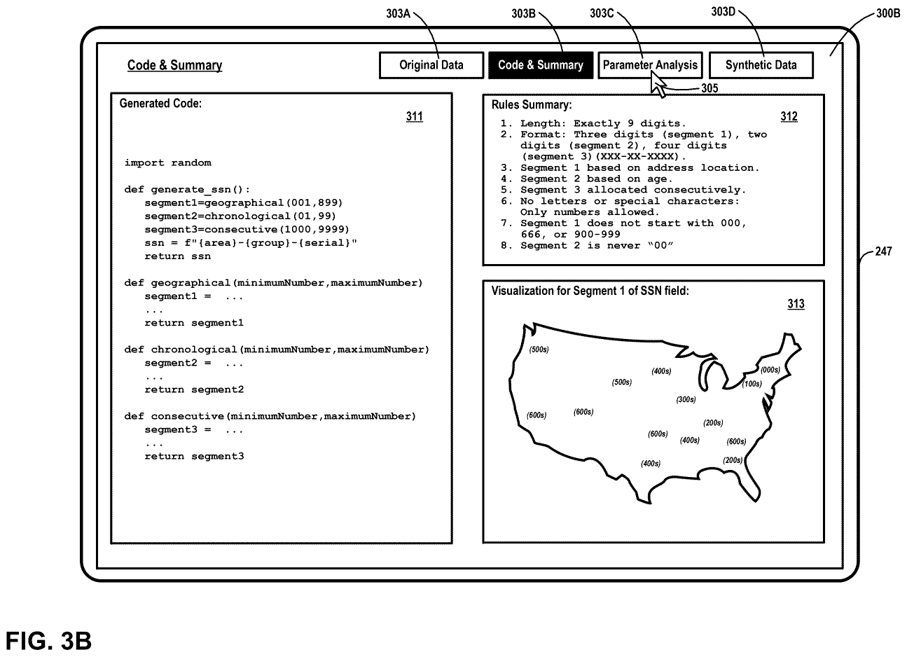

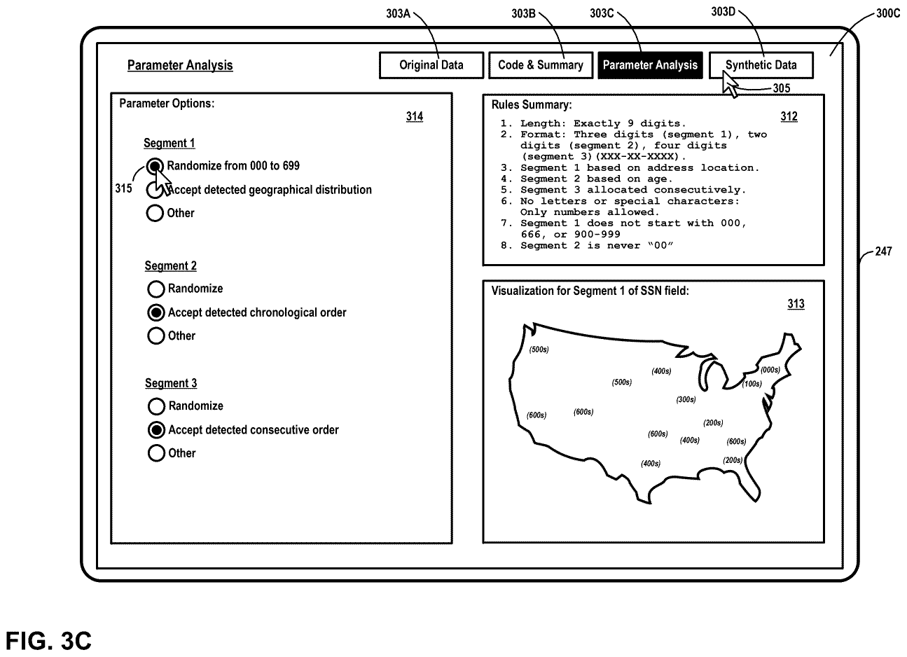

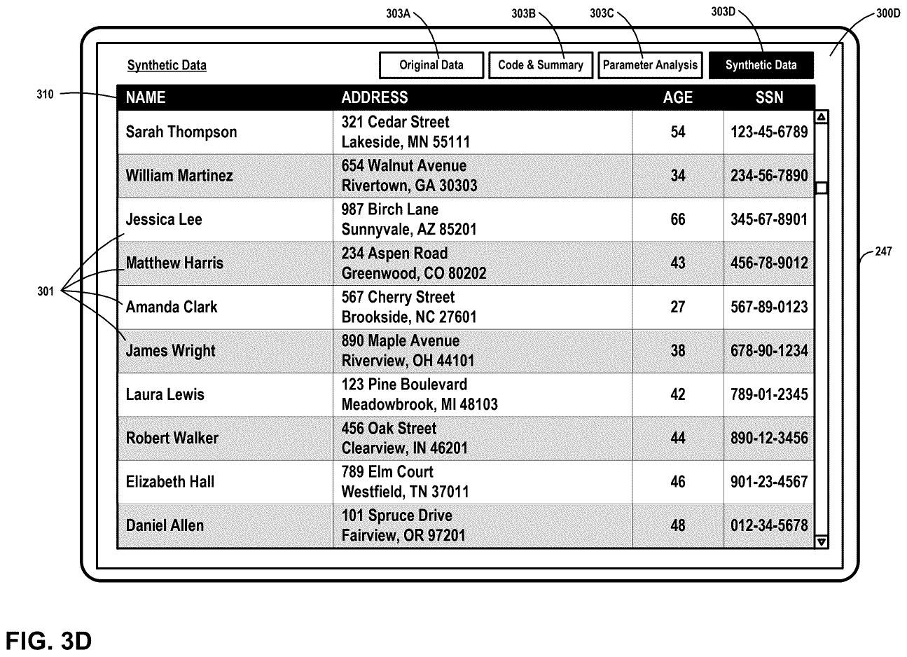

User interface module 252 may perform functions relating to managing user interactions with computing system 240. For example, user interface module 252 may cause computing system 240 to output various user interfaces for display or presentation or otherwise, as a user of computing system 240 views, hears, or otherwise senses output and/or provides input at computing system 240 or at a remote computing system over a network. In some examples, user interface module 252 may receive information and instructions from a platform, operating system, application, and/or service executing at computing system 240, at a client device, and/or one or more remote computing systems. In addition, user interface module 252 may act as an intermediary between a platform, operating system, application, and/or service executing at client device and various output devices of such a client (e.g., speakers, LED indicators, audio or electrostatic haptic output devices, light emitting technologies, displays, etc.) to produce output (e.g., a graphic, a flash of light, a sound, a haptic response, etc.). In some examples, user interface module 252 may generate one or more visualizations or user interfaces, such as the user interfaces 300A, 300B, 300C, and/or 300D illustrated in FIG. 2 and further illustrated in FIG. 3A, FIG. 3B, FIG. 3C, and FIG. 3D.

Machine learning module 253 may perform functions relating to training one or more production models 160 to make predictions or draw inferences about production data 132. In some examples, machine learning module 253 is a system or process that is capable of training a machine learning model (e.g., production model 160) by applying a machine learning process to synthetic data 131. Machine learning module 253 may use actual production data (e.g., source data 101) as synthetic data 131, where that actual production data is derived from data collected from processes relevant to production model 160 (e.g., customer data, information about input received by production business systems). In other examples, however, some or all of the synthetic data 131 that machine learning module 253 uses to train production model 160 may be synthetic, such as synthetic data 131. Machine learning module 253 may perform functions corresponding to machine learning system 153 illustrated in FIG. 1.

Data store 259 of computing system 240 may represent any suitable data structure or storage medium for storing information relating to generating and/or tracing synthetic data. The information stored in data store 259 may be searchable and/or categorized such that one or more modules within computing system 240 may provide an input requesting information from data store 259, and in response to the input, receive information stored within data store 259. Data store 259 may serve as a library for information about policies, standards, standard procedures, and/or conventions for generating various types of synthetic data. Such policies, standards, procedures, and/or conventions may, in some cases, be based on prior instances in which synthetic data was generated by computing system 240 under the control of an organization or commercial enterprise. In such an example, information stored in data store 259 may represent policies and/or standards used by that organization. In some examples, data store 259 may include demographic, geographic, or other data that enables analysis module 251 (or computing system 240 generally) to determine that code 111 might generate code inconsistent with actual distributions of such demographic, geographic, or other data. Data store 259 may be primarily maintained by analysis module 251.

Modules illustrated in FIG. 2 (e.g., analysis module 251, user interface module 252, and machine learning module 253) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

FIG. 3A through FIG. 3D are conceptual diagrams illustrating example user interfaces presented by a user interface device in accordance with one or more aspects of the present disclosure. Each of the user interfaces 300 presented in FIG. 3A through FIG. 3D (i.e., user interfaces 300A, 300B, 300C, and 300D, respectively) may correspond to user interface 300 presented or output by analysis system 151 of FIG. 1 or computing system 240 of FIG. 2. Each of user interfaces 300 may also be presented or output by computing system 240 of FIG. 2, and in such an example, any of user interfaces 300 may be presented by an output device, such as a display device included as part of computing system 240 of FIG. 2. Such a display device may be considered an example of an output device 247 of computing system 240. In some examples, such as where the display device is a presence-sensitive display (e.g., a “touch screen”), the display device may also serve as an example of an input device 246 of computing system 240.

User interface 300A may include one or more tabs 303, each of which may enable a user to change the data or user interface presented by output device 247. In the example of FIG. 3A, tab 303A is active, indicating that in the example shown, computing system 240 is presenting, through display device 247, user interface 300A. In FIG. 3A, user interface 300A illustrates a table 310 of data entitled “Original Data,” which may correspond to source data 101. In response to interactions with other tabs 303 (e.g., indications of input selecting one of tabs 303 using cursor 305), other user interfaces 300 may be presented by output device 247. For example, FIG. 3B illustrates user interface 300B, which may present a “Code & Summary” visualization of aspects of source data 101 and/or code artifacts 119 (e.g., code 111, rules 112, and/or visualization data 113). FIG. 3C illustrates user interface 300C, which may present a “Parameter Analysis” visualization or user interface capable of accepting user input relating to parameter choices. FIG. 3D illustrates user interface 300D, which may illustrate a table of synthetic data 131 (e.g., generated by code 111).

Although the user interfaces illustrated in FIG. 3A through FIG. 3D are shown as graphical user interfaces, other types of interfaces may be presented in other examples. Such user interfaces may include a text-based user interface, a console or command-based user interface, a voice prompt user interface, or any other appropriate user interface now known or hereafter developed.

FIG. 3A illustrates an example user interface providing a visualization of source or real data that may be used in model development. In FIG. 3A, and as previously described, output device 247 presents user interface 300A, which includes table 310. In the example illustrated, table 310 is a scrollable listing of individual data items 301, representing individual instances of actual source data to be used to generate synthetic data 131. Such data items 301 may represent example instances of data drawn from source data 101.

Table 310 in FIG. 3A presents example data columns, including, for each data item 301, a name, address, age, and social security number (“SSN”). Each row in the table includes the data corresponding to those columns or data fields for each data item 301. For ease of illustration, only a limited set of data fields (name, address, age, social security) are presented by table 310. However, in other examples, information about any number of data fields may be presented within table 310 or otherwise.

FIG. 3B illustrates another example user interface providing a visualization of aspects of code artifacts 119 generated by model 110. For instance, in an example that can be described with reference to FIG. 2 and FIG. 3B, input device 246 of computing system 240 detects input and outputs information about the input to user interface module 252. User interface module 252 determines that the input corresponds to a request to apply model 110 to source data 101. User interface module 252 outputs information about the input to analysis module 251. Analysis module 251 causes model 110 to generate code artifacts 119 based on source data 101. Model 110 outputs code artifacts 119 (including code 111, rules 112, visualization data 113, and parameter data 114) to user interface module 252. User interface module 252 generates data that can be used for creating a visualization of one or more aspects of code artifacts 119. User interface module 252 uses the data to cause output device 247 to present user interface 300B, as illustrated in FIG. 3B.

In FIG. 3B, code window 311 presents a code window 311, a rules window 312, and a visualization window 313. Code window 311 illustrates a listing of code generated by model 110 (i.e., the code shown in code window 311 may represent a portion of code 111). Code 111 that is generated by the model can be executed on a computing system (e.g., computing system 240) to generate synthetic data having attributes similar to source data 101. Specifically, in the example shown, code window 311 shows a representation of source code (e.g., code 111) that can be used to generate the “SSN” (i.e., “social security number”) field shown in table 310 of FIG. 3A.

In general, social security numbers, as issued in the United States, are nine-digit numbers having three parts. The way in which social security numbers are chosen, assigned, and formatted has a particular pattern, and given enough source data 101, model 110 may be able to discern some or all aspects of the pattern, and incorporate such patterns into code 111 used to generate synthetic data corresponding to the “SSN” field for source data 101. For example, the first set of three digits is called the Area Number, and historically has been assigned by geographical region, generally starting with the lowest numbers in the northeastern part of the country and moving westward. In more recent years, the geographical nature of the Area Number has become less consistent for newly assigned numbers, but the geographical bias associated with various ranges of Area Numbers still persists, particularly for social security numbers assigned to citizens a number of years ago. The second set of two digits is called the Group Number, which has historically been assigned according to a generally chronological pattern in which the odd numbers 00 through 09 were assigned, followed by even numbers 10 through 98, followed by even numbers 02 through 08, and then followed by odd numbers 11 through 99. The final set of four digits is the Serial Number, which generally has been assigned consecutively.

In some examples, model 110 might determine the pattern for the SSN without knowing that the “SSN” field is actually a social security number, so model 110 might generate code that creates the nine digit numbers for the SSN field by generating three unnamed segments, identified in code window 311 as “segment1,” “segment2,” and “segment3.” As illustrated, code 111 in code window 311 includes a function entitled “generate_ssn( )” that uses three other functions to generate the three segments of data. Those three segments are then combined into an “ssn” number having an appropriate format. In this example, the “geographical” function is presented as pseudocode that may generate data for “segment1” (corresponding to the Area Number) based on a geographical distribution determined by model 110 and as applied to the parameters passed to the function. The “chronological” function is presented as pseudocode that generates data for “segment2” (corresponding to the Group Number) based on a chronological distribution determined by model 110. Like the “geographical” function, the chronological function also operates based on parameters passed to the function. And the “consecutive” function is presented in code window 311 as pseudocode that generates data for “segment3” (corresponding to the Serial Number) based on a function that generates data in an ordinal or consecutive fashion, again based on the parameters passed to the function. The “generate_ssn( )” function then generates a string formatted to present the three segments of data in a form matching the SSN field of table 310 of FIG. 3A. Although FIG. 3B is a simplified example where code window 311 only shows code for generating synthetic data associated with the SSN field, in other examples, code window 311 might alternatively (or additionally) include code for generating synthetic data for any or all of the fields in table 310. Also, although pseudocode is presented in code window 311 of FIG. 3B, in an actual implementation, the full listing of code 111 may be presented within code window 311.

Rules window 312 of user interface 300B illustrates a list of rules that summarize one or more aspects of the code listed in code window 311. In some examples, the rules presented in rules window 312 may be a high-level summary of the code shown in code window 311. In some respects, however, the rules presented in rules window 312 might not, in at least some examples, identify all the nuances that might be included in the code listed in code window 311, such as how the geographical, chronological, and/or other distributions may be applied to generate synthetic data. Accordingly, a full understanding of how synthetic data that is generated by code 111 might be best gained through analysis of code 111 listed in code window 311.

Visualization window 313 illustrates a visualization that summarizes a geographical distribution that might represent how “segment1” of the SSN field is generated. Visualization window 313 illustrates how the three-digit numbers associated with the “segment1” (corresponding to the Area Number) portion of the SSN data field would be geographically distributed, at least generally, when synthetic data is generated by the code 111 in code window 311. For example, segment1 or Area Numbers from 0 to 200 (“000s” and “100s”) tend to be used in the eastern part of the United States, segment1 numbers in the 400s tend to be used in the middle of the country, and segment1 numbers from 500 to 700 (“500s” and “600s” tend to be used in the western part of the country. Visualization window 313 of FIG. 3B is a simplified example that includes a visualization of only one aspect of the SSN data field. In other examples, user interface 300B and/or additional visualization windows 313 may present visualizations pertaining to other aspects of the SSN data field, pertaining to other data fields of table 310, pertaining to data items 301 included in table 310, and/or pertaining to other aspects of source data 101 and/or code artifacts 119.

FIG. 3C illustrates another example user interface presenting information about parameters that might be configured or adjusted for the operation of model 110. For instance, again with reference to FIG. 2, input device 246 of computing system 240 detects input that user interface module 252 determines corresponds to an interaction with tab 303C with cursor 305 (see cursor 305 in FIG. 3B). User interface module 252 accesses parameter data 114 and generates information sufficient to generate a user interface. User interface module 252 causes output device 247 to present user interface 300C, as illustrated in FIG. 3C.

User interface 300C of FIG. 3C is similar to user interface 300B of FIG. 3B, but also includes parameter options window 314, which presents information about parameters that can be used to adjust or affect the operation of model 110. As suggested by information presented in in parameter options window 314, aspects of how each of segment 1 (corresponding to the Area Number of a social security number), segment 2 (corresponding to the Group Number, and segment 3 (corresponding to the Serial Number) are generated can be adjusted based on a parameter passed to model 110 (e.g., by parameter adjustment data 124). Initially, when model 110 generates code artifacts 119 based on source data 101, model 110 may generate each of segments 1, 2, and 3 based on a distribution or pattern discerned from source data 101. But model 110 may also determine that it may be appropriate to enable options for adjusting how the synthetic data is generated, potentially deviating from the discerned distribution or pattern.

Computing system 240 may generate new code artifacts 119 based on such parameter adjustment options. For instance, with reference to FIG. 2 and FIG. 3C, input device 246 of computing system 240 detects input that user interface module 252 determines corresponds to an interaction with radio control 315 (see parameter options window 314 of user interface 300C). User interface module 252 of computing system 240 outputs information about the input to analysis module 251. Analysis module 251 determines that the input corresponds to a request to override the geographical distribution that code 111 applies to segment 1 of the SSN field (i.e., the Area Number), and apply a uniformly or randomly distributed number to that field (see selected radio control 315 in FIG. 3C). Analysis module 251 generates parameter adjustment data 124 and outputs the parameter adjustment data 124 to model 110. Model 110 interprets parameter adjustment data 124 as an instruction to override the distribution that model 110 determined for segment 1 based on source data 101, and instead apply a uniform distribution. Model 110 then generates updated code artifacts 119, which may include new code 111 implementing the new distribution for segment 1, and may also include new rules 112, new 113, and/or new parameter data 114.

Although parameter adjustment data 124 may be generated in response to user input, as described above, computing system 240 may also generate parameter adjustment data 124 independently, without requiring user input. For instance, in some cases, analysis module 251 of computing system 240 might independently determine (e.g., based on information accessed from data store 259 or elsewhere) that applying a distribution identified by model 110 based on source data 101 would not serve the purpose for which the generated synthetic data is expected to be used. In such an example, analysis module 251 may generate parameter adjustment data 124, and output the parameter adjustment data 124 to model 110. Model 110 then interprets the parameter adjustment data 124 and overrides the one or more distributions as instructed by the parameter adjustment data 124. Model 110 may then generate updated code 111 and/or updated code artifacts 119 in response to parameter adjustment data 124. Model 110 outputs the updated information to analysis module 251, and analysis module 251 may perform further analysis on the updated information to use it to generate one or more updated user interfaces 300 for presentation within output device 247. Analysis module 251 may also update data store 259 with information about code artifacts 119, which may include information about parameter adjustment data 124 and its effect on model 110.

Computing system 240 may also modify code artifacts 119 in response to changes made directly to rules 112. For instance, user interface module 252 may detect input that it determines corresponds to on-screen editing of any information presented in user interface 300C of FIG. 3C (or other user interfaces 300), including, for example, the rules presented within rules window 312. Such editing of the rules within rules window 312 might involve one or more rules being added, deleted, or changed. In one specific example, user interface module 252 might determine that the on-screen editing corresponds to a modification of rule 8, changing rule 8 presented in rules window 312 of FIG. 3C to read “Segment 2 is never ‘00’ or ‘01’”. In such an example, user interface module 252 outputs information about the modification to analysis module 251. Analysis module 251 evaluates the modification and generates rule adjustment data 122. Analysis module 251 outputs rule adjustment data 122 to model 110. Model 110 interprets rule adjustment data 122 and uses the data to modify code 111 to incorporate this rule change to ensure that synthetic data generated by code 111 will not include any SSN fields with a segment2 (or Group Number) that is either ‘00’ or ‘01’. Model 110 generates updated code artifacts 119 (including updated code 111) and outputs the updated code artifacts 119 to analysis module 251. Analysis module 251 may perform an analysis on the updated code artifacts 119 and/or update one or more user interfaces 300. Analysis module 251 may also update data store 259 with information about code artifacts 119, which may include information about rule adjustment data 122 and its effect on model 110.

FIG. 3D illustrates an example user interface presenting synthetic data that might be generated by one or more versions of code 111. For instance, referring again to FIG. 2, input device 246 of computing system 240 detects input that user interface module 252 determines corresponds to an interaction with tab 303D with cursor 305 (see cursor 305 in FIG. 3C). User interface module 252 outputs information about the interaction to analysis module 251. Analysis module 251 executes code 111, causing synthetic data 131 to be generated. Analysis module 251 interacts with user interface module 252, and user interface module 252 causes output device 247 to present user interface 300D, as illustrated in FIG. 3D.

In FIG. 3D, output device 247 presents table 310, which is intended to illustrate a scrollable list of synthetic data generated as a result of executing code 111. Each of the data items 301 listed in table 310 therefore may be considered synthetic data generated as a result of executing code 111 as modified by any parameter adjustment data 124 and/or rule adjustment data 122 applied to model 110. Typically, none of the data items 301 include any personally identifiably information, and can be used directly by subject matter experts 120 to train models or perform analyses, as appropriate. In some examples, generating synthetic data 131 may be the result of a single click of tab 303D when viewing any of user interfaces 300A, 300B, or 300C. Further, in some examples, the data illustrated in table 310 of FIG. 3D may be used directly by one or more subject matter experts 120, and entitlements to source data 101, synthetic data 131, and/or other data may be automatically maintained or administered by computing system 240 (or an organization controlling computing system 240). Computing system 240 may perform all functions relating to preprocessing that might otherwise be required and may ensure that no files are being exported out or private information is being exposed inappropriately.

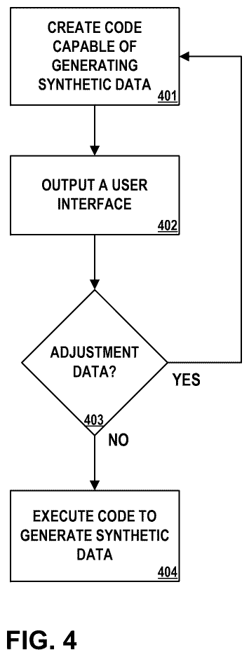

FIG. 4 is a flow diagram illustrating operations performed by an example computing system 240 in accordance with one or more aspects of the present disclosure. FIG. 4 is described below within the context of computing system 240 of FIG. 2. In other examples, operations described in connection with FIG. 4 may be performed by one or more other components, modules, systems, or devices. Further, in other examples, operations described in connection with FIG. 4 may be merged, performed in a different sequence, omitted, or may encompass additional operations not specifically illustrated or described.

In the process illustrated in FIG. 4, and in accordance with one or more aspects of the present disclosure, computing system 240 may create code capable of generating synthetic data (401). For example, with reference to FIG. 2, input device 246 of computing system 240 detects input and outputs information about the input to analysis module 251. Analysis module 251 of computing system 240 determines that the input corresponds to source data 101. Analysis module 251 applies model 110 to source data 101 and generates code 111. Code 111 may be human-readable code written in any appropriate programming language (e.g., Python, Java, C#, or others), and may have a form similar to (or even indistinguishable from) code written by a human developer. When executed on a computing system, code 111 generates synthetic data having properties patterned after the input data (i.e., source data 101). In some examples, model 110 may also generate certain other code artifacts 119 when generating code 111. Such other code artifacts 119 may include rules 112, visualization data 113, and/or parameter data 114.

Computing system 240 may output a user interface presenting information about attributes of synthetic data that the code is capable of generating (402). For example, referring again to FIG. 2, analysis module 251 outputs information about code artifacts 119 to user interface module 252. User interface module 252 uses the information about the code artifacts 119 to generate one or more visualizations or user interfaces 300 that present information about the code artifacts 119. For example, one such user interface may present code 111 for inspection and analysis by subject matter expert 120 (e.g., see FIG. 3B). In another example, a user interface may present information about rules embodied within code 111 (e.g., see FIG. 3B or 3C). Another user interface may present a visualization illustrating attributes of the synthetic data capable of being generated by code 111 (e.g., see FIG. 3B or 3C).

Computing system 240 may access adjustment data (403). For example, again with reference to FIG. 2, input device 246 detects input that user interface module 252 determines corresponds to modifications being made to code 111, rules 112, visualization data 113, and/or parameter data 114. In some examples, such modifications may correspond to on-screen modifications performed by subject matter expert 120 or by a developer.

Computing system 240 may generate updated code (YES path from 403). For example, referring again to FIG. 2, input device 246 of computing system 240 detects input that user interface module 252 determines corresponds to editing of code artifacts 119 (e.g., on-screen editing by subject matter expert 120 when viewing user interface 300B or 300C). User interface module 252 outputs information about the editing to analysis module 251. Analysis module 251 generates adjustment data (e.g., rule adjustment data 122 or parameter adjustment data 124) based on the editing. Analysis module 251 presents the adjustment data to model 110 and causes model 110 to generate updated code 111, where the updated code 111 is modified to reflect the adjustments specified in the adjustment data (see 401). In some cases, model 110 may additionally output updated code artifacts 119 (e.g., rules 112, visualization data 113, and/or parameter data 114). User interface module 252 may use the updated code artifacts 119 to present further user interfaces and/or visualizations, which may be further modified or adjusted by subject matter expert 120 (e.g., through on-screen modifications or otherwise).

Once no further adjustments are available (NO path from 403), computing system 240 may execute the final version of code 111 to generate synthetic data 131. For example, in FIG. 2, if subject matter expert 120 determines that the most recent version of updated code 111 is satisfactory, subject matter expert 120 may deem code 111 ready to generate synthetic data 131. In such an example, analysis module 251 executes code 111 to generate synthetic data 131.

Once synthetic data 131 is created, it may be used to train a model that controls other systems. For example, in FIG. 2, machine learning module 253 of computing system 240 accesses synthetic data 131 and uses synthetic data 131 to train production model 160. Once trained, production model 160 is used to make predictions 162 based on production data 132. Such predictions may be or may be the basis for control signals that are used to control the operation of one or more external systems 190 (see FIG. 2). Such external systems 190 receive the control signals and determine that the signals include instructions for performing one or more operations. One or more external systems 190 perform operations based on the signals. Accordingly, at least in this way, computing system 240 controls the operation of one or more external systems 190.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any material that is incorporated by reference conflicts with the present disclosure, the present disclosure shall control.

For ease of illustration, only a limited number of devices (e.g., analysis system 151, machine learning system 153, models 110 and 160, library 159, external systems 190, computing system 240, as well as others) are shown within the illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The illustrations included herein depict at least one example implementation of an aspect of this disclosure. The scope of this disclosure is not, however, limited to such implementations. Accordingly, other example or alternative implementations of systems, methods or techniques described herein, beyond those illustrated, may be appropriate in other instances. Such implementations may include a subset of the devices and/or components included in the illustrations and/or may include additional devices and/or components not specifically illustrated.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced illustrations in order to avoid obscuring such concepts.

Accordingly, although one or more implementations of various systems, devices, and/or components may be described with reference to specific illustrations, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated herein may alternatively be implemented as part of another device or component not shown in such illustrations. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner. References herein to “real time” or equivalent phrases are intended to encompass near-real time or seemingly near-real time, such as from the perspective of a reasonable human observer.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, graphics processing units (GPUs), application specific integrated circuits (ASICs), field programmable logic arrays (FPGAs), quantum processors, or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including, to the extent appropriate, a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is

1. A method comprising:
generating, by an artificial intelligence model executing on a computing system and based on a source dataset, code capable of generating synthetic data patterned after the source dataset;
outputting, by the computing system, a user interface presenting information about attributes of synthetic data that the code is capable of generating;
accessing, by the computing system, adjustment data; and
generating, by the artificial intelligence model and based on the adjustment data, updated code capable of generating synthetic data patterned after the source dataset and reflecting the adjustment data.

2. The method of claim 1, wherein generating code further includes generating, by the artificial intelligence model, code artifacts including at least one of:
rules describing operation of the code;
visualization data about the synthetic data that the code is capable of generating; or
parameter data.

3. The method of claim 2, wherein outputting the user interface includes:
outputting a user interface presenting the rules describing operation of the code.

4. The method of claim 2, wherein outputting the user interface includes:
outputting a user interface presenting the visualization data to illustrate an effect of at least one of the rules.

5. The method of claim 2, wherein accessing adjustment data includes:
detecting an indication of input modifying the rules.

6. The method of claim 5, wherein generating updated code includes:
translating the indication of input modifying the rules into changes to the code.

7. The method of claim 2, wherein accessing adjustment data includes:
detecting, by the computing system, an indication of input modifying the visualization data.

8. The method of claim 7, wherein generating updated code includes:
translating the indication of input modifying the visualization data into changes to the code.

9. The method of claim 2, wherein accessing adjustment data includes:
detecting, by the computing system, an indication of input modifying the parameter data.

10. The method of claim 9, wherein generating updated code includes:
translating the indication of input modifying the parameter data into changes to the code.

11. The method of claim 1, wherein generating updated code further includes generating, by the artificial intelligence model, updated code artifacts including at least one of:
updated rules describing operation of the updated code;
updated visualization data about synthetic data that the updated code is capable of generating; or
updated parameter data.

12. The method of claim 1, further comprising:
generating, by the computing system and based on the updated code, synthetic data;
training, by the computing system and based on the synthetic data, a machine learning model;
applying, by the computing system, the machine learning model to input data to generate a prediction; and
sending, by the computing system and based on the prediction, control signals to an external system to instruct the external system to perform an operation.

13. A computing system comprising processing circuitry and a storage device, wherein the processing circuitry has access to the storage device and is configured to:
generate, using an artificial intelligence model and based on a source dataset, code capable of generating synthetic data patterned after the source dataset and reflecting the adjustment data;
output a user interface presenting information about attributes of synthetic data that the code is capable of generating;
access adjustment data; and
generate, using the artificial intelligence model and based on the adjustment data, updated code capable of generating synthetic data patterned after the source dataset.

14. The system of claim 13, wherein to generate code, the processing circuitry is further configured to generate, using the artificial intelligence model, code artifacts including at least one of:
rules describing operation of the code;
visualization data about the synthetic data that the code is capable of generating; or
parameter data.

15. The system of claim 14, wherein to output the user interface, the processing circuitry is further configured to:
output a user interface presenting the rules describing operation of the code.

16. The system of claim 14, wherein to output the user interface, the processing circuitry is further configured to:
output a user interface presenting the visualization data to illustrate an effect of at least one of the rules.

17. The system of claim 14, wherein to access adjustment data, the processing circuitry is further configured to:
detect an indication of input modifying the rules.

18. The system of claim 17, wherein to generate updated code, the processing circuitry is further configured to:
translate the indication of input modifying the rules into changes to the code.

19. The system of claim 13, wherein the processing circuitry is further configured to:
generate, based on the updated code, synthetic data;
train, based on the synthetic data, a machine learning model;
apply the machine learning model to input data to generate a prediction; and
send, based on the prediction, control signals to an external system to instruct the external system to perform an operation.

20. Non-transitory computer-readable media comprising instructions that, when executed, cause processing circuitry of a computing system to:
generate, using an artificial intelligence model and based on a source dataset, code capable of generating synthetic data patterned after the source dataset and reflecting the adjustment data;
output a user interface presenting information about attributes of synthetic data that the code is capable of generating;
access adjustment data; and
generate, using the artificial intelligence model and based on the adjustment data, updated code capable of generating synthetic data patterned after the source dataset.
